(19) United States
(12) Patent Application Publication
(10) Pub. No.: US 2007/0179901 A1
(43) Pub. Date: Aug. 2, 2007

(54) Secure gateway providing adaptable access to services

(76) Inventor: Roman Kresina, Oxford, CT (US)

Correspondence Address: KENYON & KENYON LLP, 1500 K STREET N.W., SUITE 700, WASHINGTON, DC, 20005, US

(21) Appl. No.: 11/343,758

(22) Filed: Jan. 31, 2006

(51) Int. Cl. G06Q 99/00

(52) U.S. Cl. 705/60

(57) ABSTRACT

A secure gateway for a postal services infrastructure includes a server for receiving credentials from a meter and operable to authenticate the meter utilizing the credentials, and circuitry for providing services from information associated with the authenticated meter.

### BACKGROUND

The disclosed embodiments relate to a secure gateway to a postal service provider infrastructure that provides access to different services.

### BRIEF DESCRIPTION OF RELATED DEVELOPMENTS

A high volume postal customer may use a meter which incorporates a Postal Security Device (PSD) to secure the proof of payment of postal indicia. In an exemplary application, indicia may be applied to mailing items that identifies the value of the postage applied and other information. A customer may purchase postage and the purchased value may be stored in the PSD. As the postage indicia is applied to items, the value applied may be deducted from the stored value. Once postage indicia is applied, the item may then be dropped into the collection stream of the particular postal system and subsequently processed for delivery. A customer generally purchases postage, may download new features, and accesses other services by having the meter communicate with a postal service infrastructure, either automatically or manually.

It would be advantageous to authenticate a user attempting to utilize services provided by a postal services infrastructure and, if necessary, to allow the user to authenticate the postal services provider. It would also be advantageous to provide or prohibit services based on identifying data associated with the requesting user.

### SUMMARY OF THE DISCLOSED EMBODIMENTS

The disclosed embodiments are directed to a secure gateway to a postal services infrastructure. The secure gateway includes a server for receiving credentials from a meter and operable to authenticate the meter utilizing the credentials, and circuitry for providing services from information associated with the authenticated meter.

In another embodiment, a method of providing postal services includes receiving credentials from a meter, authenticating the meter using the credentials, and providing postal services using information about the authenticated meter.

In other embodiments the credentials may include a digital certificate and a message encrypted with a private key. The information associated with the authenticated meter may be included in the digital certificate. The information associated with the authenticated meter may also be included in a services list stored by the meter or may be included in a services list stored by the secure gateway.

### BRIEF DESCRIPTION OF THE DRAWINGS

The foregoing aspects and other features of the disclosed embodiments are explained in the following description, taken in connection with the accompanying drawings, wherein:

FIG. 1 shows an exemplary secure gateway for a postal services infrastructure according to the disclosed embodiments;

FIG. 2 shows a block diagram of a meter that utilizes the services of the postal services infrastructure;

FIG. 3 shows a diagram of a message for service from the meter in the form of a URL; and

FIG. 4 shows an exemplary flow diagram of a method according to the exemplary embodiments.

### DETAILED DESCRIPTION OF THE EXEMPLARY EMBODIMENTS

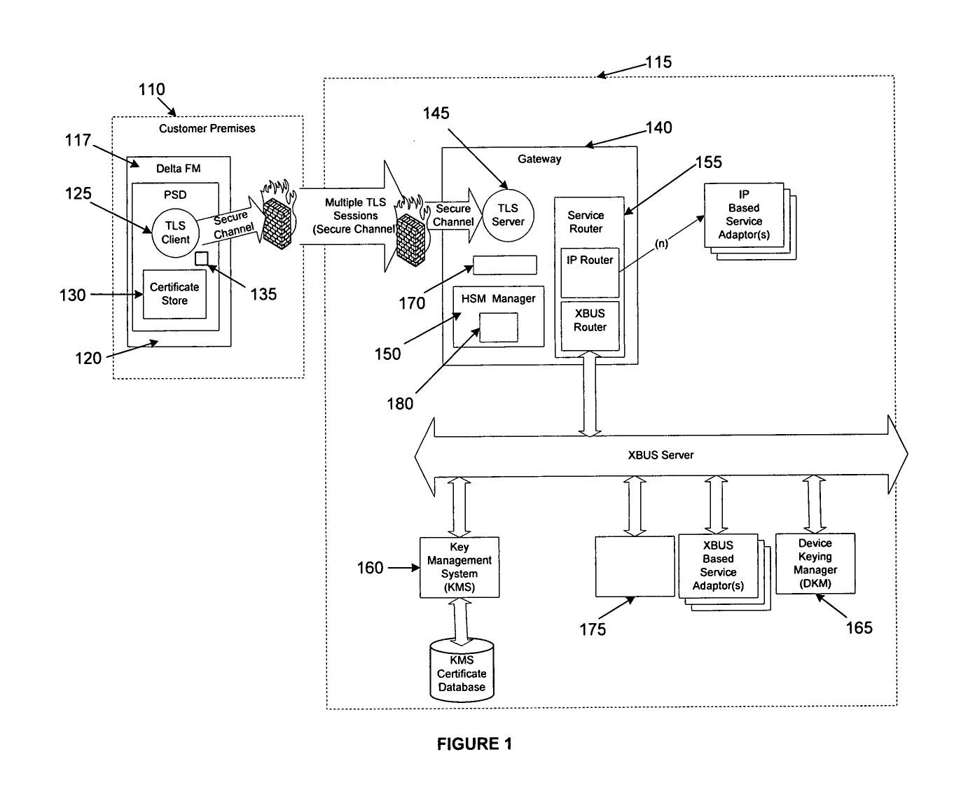

FIG. 1 shows a block diagram of a system 100 suitable for practicing the embobiments disclosed herein. Although the exemplary embodiments will be described with reference to the embodiment shown in the drawings, it should be understood that they may be embodied in many alternate forms. In addition, any suitable size, shape or type of elements or materials could be used.

The disclosed embodiments provide a secure gateway to services offered by a postal service infrastructure, where access to certain services is provided or prohibited based on results of a one or two way authentication, identifying data associated with the requesting entity, or a combination of both.

The system 100 includes equipment at a customer site 110 and a postal service infrastructure 115. The equipment located at the customer site generally includes a meter or other computing device 117 that includes an application 120 that houses a Transport Layer Security (TLS) or Secure Sockets Layer (SSL) client 125, a certificate store 130, and one or more public key private pairs 135 allowing secure TCP/IP communications.

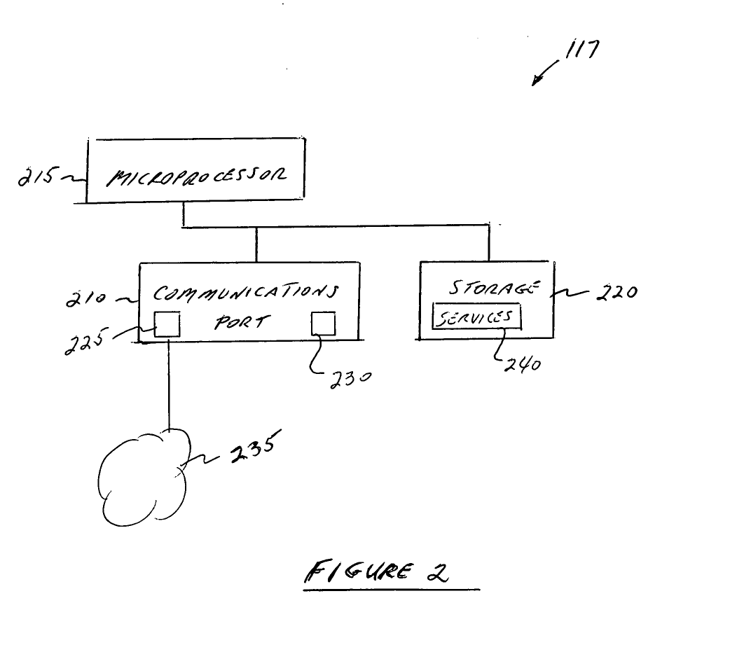

FIG. 2 shows a general block diagram of the meter 117. Meter 115 may include a communications port 210 and a microprocessor 215 for performing electronic accounting functions, control functions, and franking functions according to programs stored in a storage device 220. The control functions include the application 120, the Transport Layer Security (TLS) or Secure Sockets Layer (SSL) client 125, the certificate store 130, and the one or more public key private pairs 135. Some of these functions or subsets of these functions may be grouped within a secure perimeter, commonly referred to as a Postal Security Device (PSD).

Storage device 220 may store machine readable program code which is adapted to cause microprocessor 215 to perform the functions of the disclosed embodiments. Storage device 220 may utilize optical, magnetic, semiconductor, electronic, or other types of suitable devices to store the program code.

Microprocessor 215 typically also performs electronic accounting functions in relation to franking items. Data associated with the accounting functions may be stored in registers for an accumulated total value of credit entered into the PSD, an accumulated total value of charges dispensed by the PSD by franking items, a count of the number of items franked, and a count of the number of items franked with a charge in excess of a predetermined value. The various registers may be located in storage device 220.

The franking functions performed by the microprocessor 215 typically include providing an indication, funds, or other authorization to produce indicia, and reporting the number of items, value marked and other parameters to the accounting functions. Such indication, funds, or other authorization are referred to herein as indicia services.

The control functions performed by microprocessor 215 may include utilizing the communications port 210 to communicate with the postal service provider 115. Communications port 210 generally includes an interface 225 and support circuitry 230 for communicating with the postal service provider infrastructure 115 through one or more networks 235.

Referring to FIG. 1, the postal service infrastructure 115 includes a gateway 140 that provides a secure connection between the meter 117 and the postal service infrastructure 115. The gateway 140 includes an SSL/TLS server 145, a hardware security module manager 150 for storing keys, and a service router 155. The service router 155 provides a path to various services, including a key management system 160 having a certificate database 165 and a device keying manager 170. Other services may include meter accounting functions, funds refresh, diagnostics, provision of new functions, etc. The postal service infrastructure 115 and in particular the gateway 145 may be implemented using various computing devices, storage devices, programs, and applications, including for example, hardware, software, or any combination thereof.

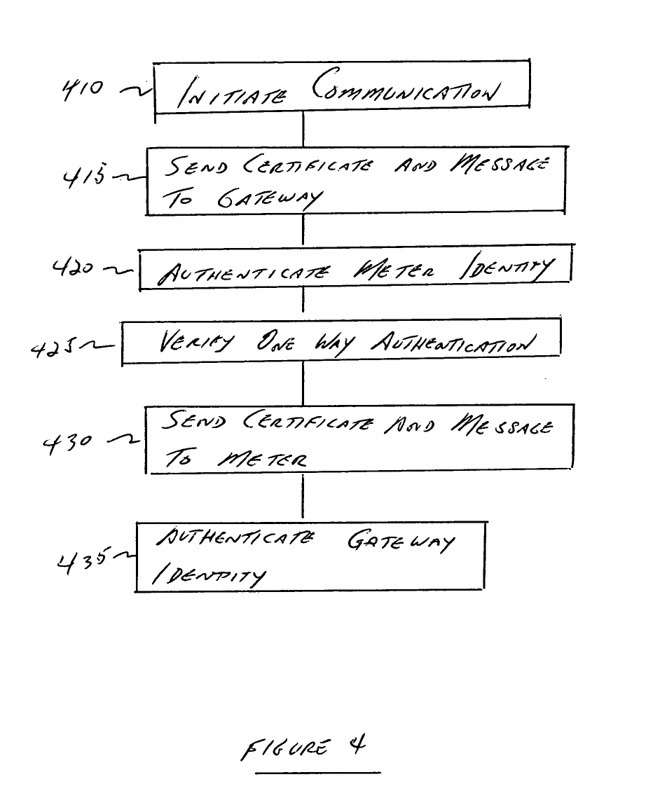

Referring to FIGS. 1 and 4, the SSL/TLS server 145 creates an authenticated secure session between the meter 117 and the postal service infrastructure 115. Communication may be initiated by either the meter 117 or the gateway 140 (block 410). At some time, for example, during communications, the meter 117 may generate a digital certificate binding the meter's identity to one or more of the meter's public keys, and a message encrypted with one or more of the meter's private keys from the one or more public key private key pairs 135. Alternately, the digital certificate may be installed in the meter 117 during manufacture, or downloaded from the postal service infrastructure 115 or some other computing device.

The meter's digital certificate integrated with the encrypted message are sent to the gateway 140 (block 415). The SSL/TLS server 145 authenticates the identity of the meter 117 by authenticating the content of the encrypted message by decrypting the message using the meter's public key as identified by the digital certificate (block 420). This process provides a one-way authentication that the gateway 140 may use to allow the meter 117 to access certain services. The one-way authentication establishes that the gateway 140 is communicating with a meter that may legitimately utilize the services of the postal services infrastructure 115. The meter 117 and the SSL/TLS server 145 may exchange further messages signaling or alerting each other as to the one way authentication (block 425).

For other services, two way authentication may be required by the meter 117 or the gateway 140 or both. For two way authentication, the SSL/TLS server 145 may generate a digital certificate, or may obtain a digital certificate from the certificate database 175, where the certificate binds the gateway's identity to one or more gateway public keys. The SSL/TLS server 145 may also generate a message encrypted with one or more of the gateway's private keys. The gateway 140 may obtain the one or more public key private key pairs from the hardware security module manager 150, key management system 160, or device keying manager 170.

The gateway's digital certificate integrated with the encrypted message are sent to the meter 117 (block 430). The meter 117 authenticates the identity of the gateway 140 by authenticating the content of the encrypted message by decrypting the message using the gateway's public key as identified by the digital certificate (block 435). This process provides a two-way authentication that the gateway 140 may use to allow the meter 117 to access other services. The two-way authentication establishes that the gateway 140 is communicating with a meter that may legitimately utilize the services of the postal services infrastructure 115, and also establishes that the meter 117 is communicating with a gateway that may legitimately offer services.

In one embodiment, the two-way authentication may allow the gateway to provide access to services provided as a result of the one-way authentication process described above, in addition to services provided as a result of the two-way authentication process. The meter 117 and the gateway 140 may exchange further messages signaling or alerting each other as to the two-way authentication.

Upon authentication, the gateway 140 may utilize various techniques to ascertain the services that may be utilized by the meter 117. Generally, the gateway 140 includes circuitry or programs that utilize information associated with the meter 117 to determine the services the meter may utilize. In one embodiment, the meter's digital certificate may include information describing the services the meter 117 is permitted to use. Thus, upon completing a one-way authentication, the gateway may determine which services the meter may access and may determine if two-way authentication is required.

In another embodiment, the meter may store a services list 240 within storage device 220 describing the permitted services. A services list 175 (FIG. 1) may alternately or additionally be stored in the postal services infrastructure 115 for the meter 117. The gateway may operate to request the services list 240 from the meter or may access the local services list 175 and utilize the list to determine the services accessible by the meter 117. In another embodiment, each of the services may be given a classification, for example, level A, level B, etc., and the meter services list 175, 240 may designate which service classifications the meter may access. This might eliminate a need to update the meter certificate or the services list in the event a service is added, deleted or changed. Each of the techniques used to ascertain the services that may be accessed by the meter 117 may also modify the available services based on a one-way or two-way authentication.

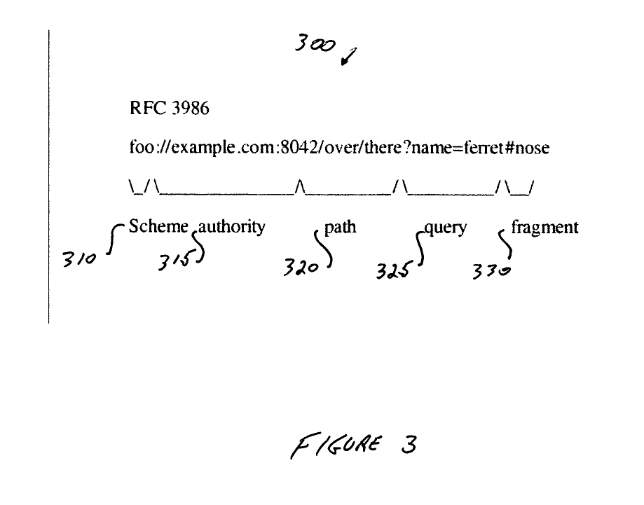

Upon establishing a connection to the gateway 140, the meter presents a message for service. The message 300 may have various forms, for example, the meter 117 may present a Uniform Resource Locator (URL) for the desired service as shown in FIG. 3. The URL 300 may include a scheme 310, an authority 315, a path 320, a query or request for service 325, and a fragment 330 which may include further data regarding the requested service.

The gateway analyses the message for service 300 to determine if the request is permitted using the techniques described above. If the service is allowed, the service router routes the message or URL to the appropriate destination service.

The hardware security module manager 150 is responsible for maintaining a dynamic list of a set of hardware security modules 180 that are currently available. Each hardware security module 180 is capable of generating public/private key pairs under the direction of the key management system 160. There may be multiple hardware security modules 180.

The key management system 160 generally provides key and certificate management services required by the gateway 140 in combination with the device keying manager 165. The key management system may be used to store and retrieve keys and certificates for postal service infrastructure users including meter 117. The device keying manager 165 may be responsible for all of the business logic necessary for re-keying meter 117 as required. For example, in one embodiment, a new certificate and public key private key pair may be generated by the gateway 140 after each transaction with the meter 117 and transmitted to the meter 117 for use with the next transaction.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A secure gateway to a postal services infrastructure, comprising:
a server for receiving credentials from a meter and operable to authenticate the meter utilizing the credentials; and
circuitry for providing services from information associated with the authenticated meter.

2. The secure gateway of claim 1, wherein the credentials include a digital certificate and a message encrypted with a private key.

3. The secure gateway of claim 2, wherein the information associated with the authenticated meter is included in the digital certificate.

4. The secure gateway of claim 1, wherein the information associated with the authenticated meter is included in a services list stored by the meter.

5. The secure gateway of claim 1, wherein the information associated with the authenticated meter is included in a services list stored by the secure gateway.

6. A method of providing postal services comprising:
receiving credentials from a meter;
authenticating the meter using the credentials; and
providing postal services using information about the authenticated meter.

7. The method of claim 6, wherein the credentials include a digital certificate and a message encrypted with a private key.

8. The method of claim 7, wherein the information associated with the authenticated meter is included in the digital certificate.

9. The method of claim 6, wherein the information associated with the authenticated meter is included in a services list stored by the meter.

10. The method of claim 6, wherein the information associated with the authenticated meter is included in a services list stored by the secure gateway.
